(19) United States
(12) Patent Application Publication
(10) Pub. No.: US 2024/0199266 A1
(43) Pub. Date: Jun. 20, 2024

(54) DEVICE FOR APPLYING A LABEL TO A PRODUCT

(71) Applicant: Precision Dynamic Fabrication Ltd., Surrey (CA)

(72) Inventor: Paul Wayne Van Tassel, North Delta (CA)

(21) Appl. No.: 18/526,874

(22) Filed: Dec. 1, 2023

Related U.S. Application Data
(60) Provisional application No. 63/433,912, filed on Dec. 20, 2022.

(51) Int. Cl. B65C 9/26; B65C 9/10; B65C 9/40

(52) U.S. Cl. CPC B65C 9/26; B65C 9/10; B65C 9/40

(57) ABSTRACT

A device for applying a label to a product includes a movable arm and a label applicator attached to the arm. The label applicator includes a label holder with a front surface for gripping the label, as well as a label fastener for attaching the label to the product. The label fastener is translatable relative to the label holder in a direction parallel to the front surface.

### CROSS REFERENCE TO RELATED PATENTS

This application claims priority from U.S. Provisional Patent Application No. 63/433,912 filed on De. 20, 2022, the entire disclosure of which is part of the disclosure of the present application and is hereby incorporated by reference in its entirety.

### FIELD OF THE INVENTION

The present disclosure relates to label application, and in particular to a device for applying a label to a product, such as lumber.

### BACKGROUND

In the lumber industry, it is typical to apply labels to stacks of finished lumber. The label may indicate, for example, the type/quality/grade of the lumber in the stack. Automated label applicators have been used in the past to automate the application of labels to such products. Typically, a label dispenser dispenses a pre-formed label that is then picked up and applied to the product.

Depending on the nature of the label as well as how the label is dispensed from the label dispenser, it may be difficult for the label applicator to effectively grip and handle the label.

### SUMMARY

According to a first aspect of the disclosure, there is provided a device for applying a label to a product, comprising: a movable arm; and a label applicator attached to the arm, wherein the label applicator comprises: a label holder comprising a front surface for gripping the label; and a label fastener for attaching the label to the product, wherein the label fastener is translatable relative to the label holder in a direction parallel to the front surface.

The product may comprise lumber.

The label holder may comprise a vacuum-generating device.

The label fastener may comprise at least one staple gun.

The arm may be movable to position the label holder in an orientation such that the label fastener is movable relative to the label holder within a horizontal plane.

The arm may be an articulated arm operable to move within at least four degrees of freedom.

The label fastener is movable between a first position and a second position relative to the label holder, and the label fastener may be further movable between the first position and a third position relative to the label holder.

When in the third position, the label fastener may extend beyond the front surface of the label holder.

The label holder may comprise at least one recessed portion for enabling the label fastener to move from the first position to the third position relative to the label holder.

The label fastener may be translatable relative to the label holder by at least 1.5 inches in the direction parallel to the front surface.

The device may further comprise one or more controllers configured to: translate the label fastener relative to the label holder; move the arm to position the label applicator in a label pick-up position relative to a label dispenser operable to dispense the label; activate the label holder to grip the dispensed label; move the arm to position the label applicator in a label-attaching position relative to the product; and activate the label fastener to attach the gripped label to the product.

The one or more controllers may be further configured to activate the label fastener by: activating the label fastener to attach a first portion of the gripped label to the product; move the label fastener relative to the label holder; and activate the label fastener to attach a second portion of the gripped label to the product.

According to a further aspect of the disclosure, there is provided a system comprising: a label dispenser operable to dispense a label; and a device for applying the label to a product, comprising: a movable arm; and a label applicator attached to the arm, wherein the label applicator comprises: a label holder comprising a front surface for gripping the label; and a label fastener for attaching the label to the product, wherein the label fastener is movable relative to the label holder such that sufficient clearance is provided to enable the label holder to grip the label dispensed by the label dispenser.

The label dispenser may be operable to dispense the label in a horizontal orientation.

The label may be a non-adhesive label.

According to a further aspect of the disclosure, there is provided a method of applying a label to a product, wherein: the method uses a label applicator comprising: a label fastener; and a label fastener movable relative to the label holder; and the method comprises: moving the label fastener relative to the label holder such that sufficient clearance is provided to enable the label holder to grip the label dispensed by a label dispenser; positioning the label applicator in a label pick-up position relative to the label dispenser operable to dispense the label; gripping the dispensed label with the label holder; positioning the label applicator in a label-attaching position; and attaching the gripped label to the product with the label fastener.

This summary does not necessarily describe the entire scope of all aspects. Other aspects, features, and advantages will be apparent to those of ordinary skill in the art upon review of the following description of specific embodiments.

### BRIEF DESCRIPTION OF THE DRAWINGS

Embodiments of the disclosure will now be described in detail in conjunction with the accompanying drawings of which:

FIG. 1 shows an exploded view of a label applicator according to an embodiment of the disclosure;

FIGS. 2A-2C show different configurations of the label applicator of FIG. 1, with a label holder and label fastener in different relative positions, according to embodiments of the disclosure;

FIGS. 3A-3C show side-on views of the label applicator as shown in FIGS. 2A-2C;

FIGS. 4A and 4B show perspective and side-on views of a label application system for applying a label to a product, according to an embodiment of the disclosure;

FIGS. 5A and 5B show side-on views of the label application system with the label applicator in different configurations, according to embodiments of the disclosure;

FIG. 6 shows the label application system with the label applicator in a label pick-up position, according to an embodiment of the disclosure;

FIGS. 7A and 7B show respective perspective and side-on views of the label application system with the label applicator being moved to a label-attaching position, according to an embodiment of the disclosure;

FIGS. 8A and 8B show respective perspective and side-on views of the label application system with the label applicator in the label-attaching position, according to an embodiment of the disclosure;

FIGS. 9A and 9B show side-on views of the label application system with the label fastener being activated, according to an embodiment of the disclosure;

FIGS. 10A and 10B show side-on views of the label application system with the label fastener being repositioned and reactivated, according to an embodiment of the disclosure;

FIG. 11 shows the label applicator relative to a label dispenser, with the label fastener displaced relative to the label holder, according to an embodiment of the disclosure;

FIGS. 12A and 12B show respective correct and incorrect positioning of the label fastener relative to the label holder, according to an embodiment of the disclosure; and

FIG. 13 shows a flow diagram of a method of attaching a label to a product, according to an embodiment of the disclosure.

### DETAILED DESCRIPTION

The present disclosure relates to a device for applying a label to a product, a label application system for applying a label to a product, and methods of applying a label to a product. While various embodiments of the disclosure are described below, the disclosure is not limited to these embodiments, and variations of these embodiments may well fall within the scope of the disclosure which is to be limited only by the appended claims.

Generally, according to embodiments of the disclosure, there is described a label-applying device for applying a label to a product, such as lumber. The device includes a movable arm that may be movable, for example, within multiple degrees of freedom. The device further includes a label applicator attached to the arm, the label applicator comprising a label holder having a front surface for gripping the label, and a label fastener for attaching the label to the product. For example, the label holder may include a vacuum pad for gripping the label through the generation of suction, and the label fastener may include one or more staple guns for attaching the gripped label to the product using staples that are driven through the label and into the product. The label fastener is movable (for example, translatable) relative to the label holder and in a direction that is parallel to the front surface.

Advantageously, by allowing the label fastener to be movable relative to the label holder, additional clearance may be provided between the label applicator and a label dispenser that has dispensed the label. This may allow the label holder to be moved into a position such that the label holder may more easily grip the label as soon as it is dispensed by the dispenser, and may reduce the risk that the gripping may fail, possibly with the label falling to the ground and being irretrievable by the label-applying device. This may be particular useful for labels that are dispensed in a horizontal orientation. Unlike labels that are dispensed in the vertical direction, gravity works against horizontally-dispensed labels such that horizontally-dispensed labels may be more difficult to grip without the added clearance provided by the displacement of the label fastener relative to the label holder as described above. With that being said, embodiments of the disclosure may be equally useful for vertically-dispensed labels, to improve the effectiveness of the gripping operation.

Turning now to the drawings, embodiments of the label-applying device will be described in further detail.

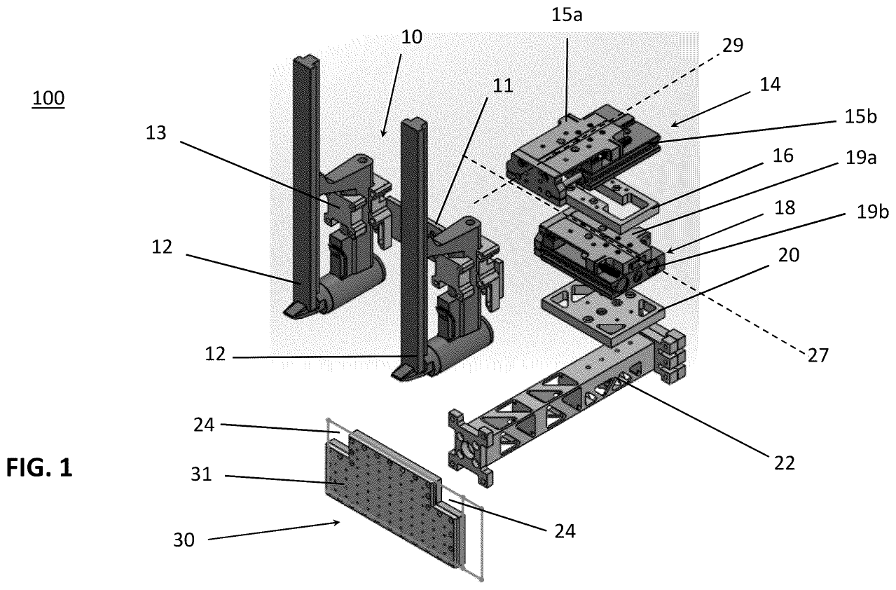

Turning first to FIG. 1, there is shown a label applicator 100 according to an embodiment of the disclosure. Label applicator 100 includes a label fastener 10 movably connected to a staple slide cylinder 14. Staple slide cylinder 14 is mounted on a first mounting plate 16 that is itself movably connected to a shift slide cylinder 18. Shift slide cylinder 18 is mounted on a second mounting plate 20.

Label applicator 100 further includes a label holder 30 secured to a central mounting assembly 22. Mounting plate 20 is secured to central mounting assembly 22 such that label fastener 10, staple slide cylinder 14, first mounting plate 16, shift slide cylinder 18, and second mounting plate 20 are connected to label holder 30 via central mounting assembly 22.

Label fastener 10 includes a pair of staples guns 12. Staples guns 12 are interconnected to each other using a staple mount bar 11 and a stapler grip mount 13 on each staple gun 12. Label holder 30 comprises a planar, generally rectangular-shaped vacuum pad 31. Vacuum pad 31 includes a pair of rectangular recessed portions 24 at upper corners of vacuum pad 31.

Shift slide cylinder 18 includes an upper portion 19a that is slidable relative to a lower portion 19b of shift slide cylinder 18. By sliding upper portion 19a relative to lower portion 19b, label fastener 10 may be moved in a lateral direction 27 to either side of central mounting assembly 22.

Similarly, staple slide cylinder 14 includes an upper portion 15a that is slidable relative to a lower portion 15b of staple slide cylinder 14. By sliding upper portion 15a relative to lower portion 15b, label fastener 10 may be moved in a longitudinal direction 29 relative to vacuum pad 31.

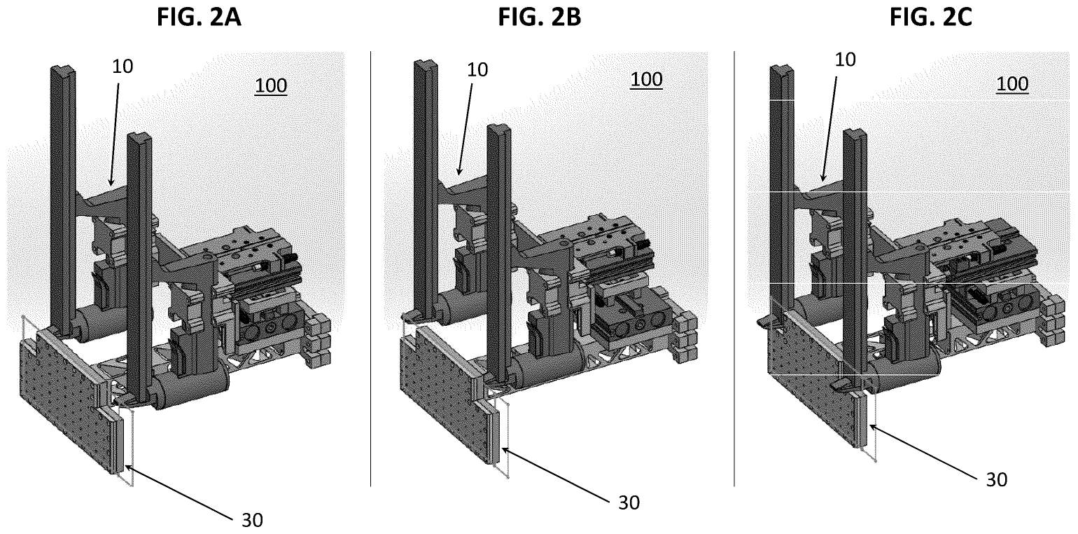

Turning to FIGS. 2A-2C, there are shown various different configurations of label applicator 100. Starting first with FIG. 2A, label fastener 10 is shown in a first configuration/position relative to label holder 30. In this first configuration, staple guns 12 are aligned with recessed portions 24 of vacuum pad 31, and upper portion 19a of shift slide cylinder 18 is in a centered, non-offset position relative to lower portion 19b of shift slide cylinder 18.

As described in further detail below, label fastener 10 is slidable relative to label holder 30 such that label fastener 10 may move from the first configuration to a second configuration/position as shown in FIG. 2B. In FIG. 2B, upper portion 19a of shift slide cylinder 18 has been slid in the lateral direction 27 such that staple guns 12 are no longer aligned with recessed portions 24, and such that label fastener 10 is offset relative to central mounting assembly 22 and label holder 30.

Turning now to FIG. 2C, there is shown a further configuration of label applicator 100 wherein label fastener 10 is moved from the first configuration (FIG. 2A) to a third configuration/position. In the third configuration, upper portion 15a of staple slide cylinder 14 has been slid in the longitudinal direction 29 relative to lower portion 15b of staple slide cylinder 14 such that staple guns 12 protrude forward of the plane defined by vacuum pad 31, with recessed portions 24 accommodating the protruding portions of staple guns 12.

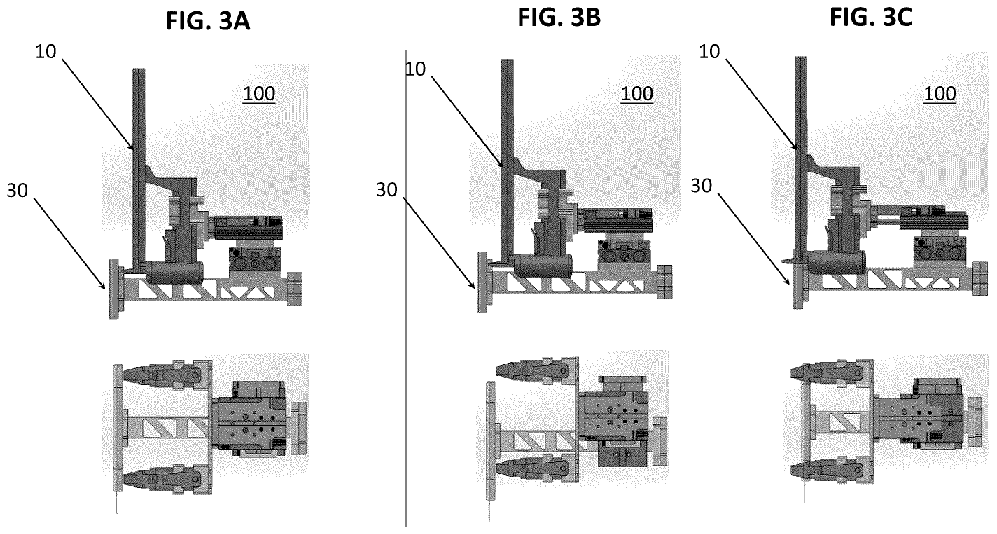

FIGS. 3A-3C show from different angles the different configurations of label applicator 100, as described above.

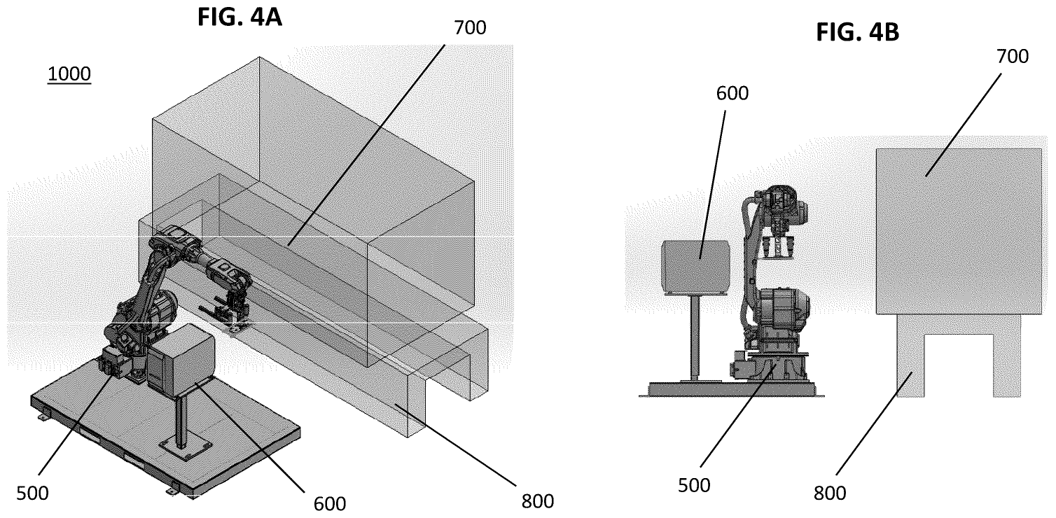

Turning now to FIGS. 4A and 4B, there is shown a label application system 1000 for applying a label to a product, such as lumber, according to an embodiment of the disclosure. Label application system 1000 includes an articulating, robotic arm 500 with label applicator 100 secured at an end thereof, a label dispenser 600, lumber 700, and a conveyor 800. According to various embodiments, robotic arm 500 may be movable within multiple degrees of freedom. For example, robotic arm 500 may be movable within at least six degrees of freedom, but may also be movable within fewer degrees of freedom, such as four or five degrees of freedom.

Using conveyor 800, lumber 700 (or any other suitable product) is brought within proximity of robotic arm 500. As described in further detail below, robotic arm 500 is configured to move label applicator 100 between a label pick-up position and a label-attaching position. As will be described in further detail below, in the label pick-up position, robotic arm 500 moves label applicator 100 to a position sufficiently close to label dispenser 600 so as to enable label applicator 100 to pick-up and hold onto a label that has been dispensed by label dispenser 600. Robotic arm 500 is then configured to move label applicator 100 from the label pick-up position to the label-attaching position. In the label-attaching position, robotic arm 500 moves label applicator 100 to a position sufficiently close to lumber 700 to enable label applicator 100 to attach the label being held by label applicator 100 to lumber 700. The process may then be repeated, by controlling robotic arm to alternatively move label applicator 100 between the label pick-up and label-attaching positions, every time a new piece of lumber (or other product) is conveyed to the position shown in FIGS. 4A and 4B.

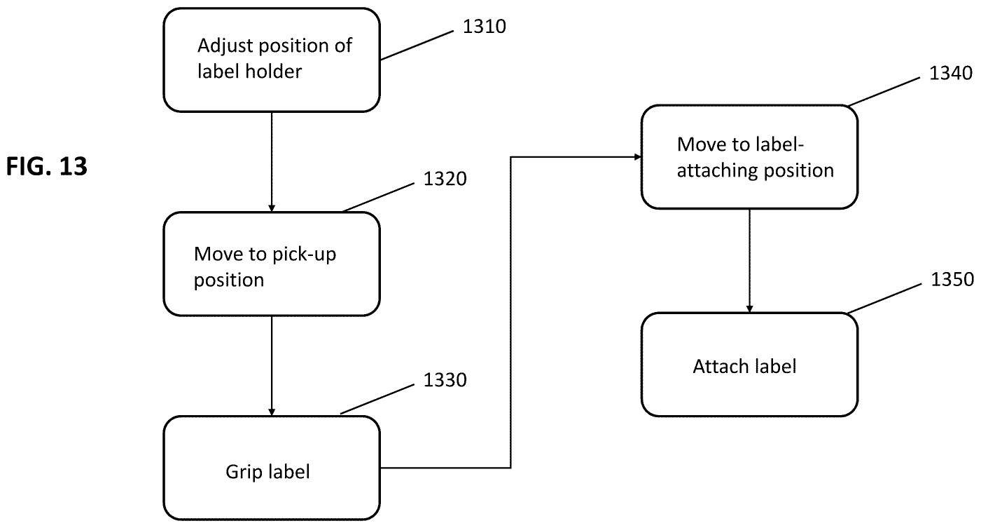

With reference now to FIG. 13, there is described a general method of applying a label to a product, using label application system 1000 as shown in FIGS. 4A and 4B.

At block 1310, the position of label fastener 10 relative to label holder 30 is adjusted to provide sufficient clearance for enabling label holder 30 to grip a label that has been dispensed from label dispenser 600.

At block 1320, robotic arm 500 moves label applicator 100 to a label-pick position.

At block 1330, label holder 30 grips the label as the label is being dispensed from label dispenser 600. Generally, label holder 30 is moved into correct alignment with label dispenser 600 prior to label dispenser 600 dispensing the label. As the label is printed/dispensed, label holder 30 then catches/grips the dispensed label.

At block 1340, robotic arm 500 moves label applicator 100, including the gripped label, to a label-attaching position.

At block 1350, label fastener 10 is controlled to attach the gripped label to lumber 700.

Generally, robotic arm 500 and label applicator 100 (including its various components) are controlled using one or more computer processors/control units. Such controllers may be located on the platform on which is provided robotic arm 500, but could also be located elsewhere. Communication between the controllers and robotic arm 500/label applicator 100 may be achieved through the use of wired or wireless means. According to some embodiments, the controllers may be based on analogue circuitry instead of digital computer processors.

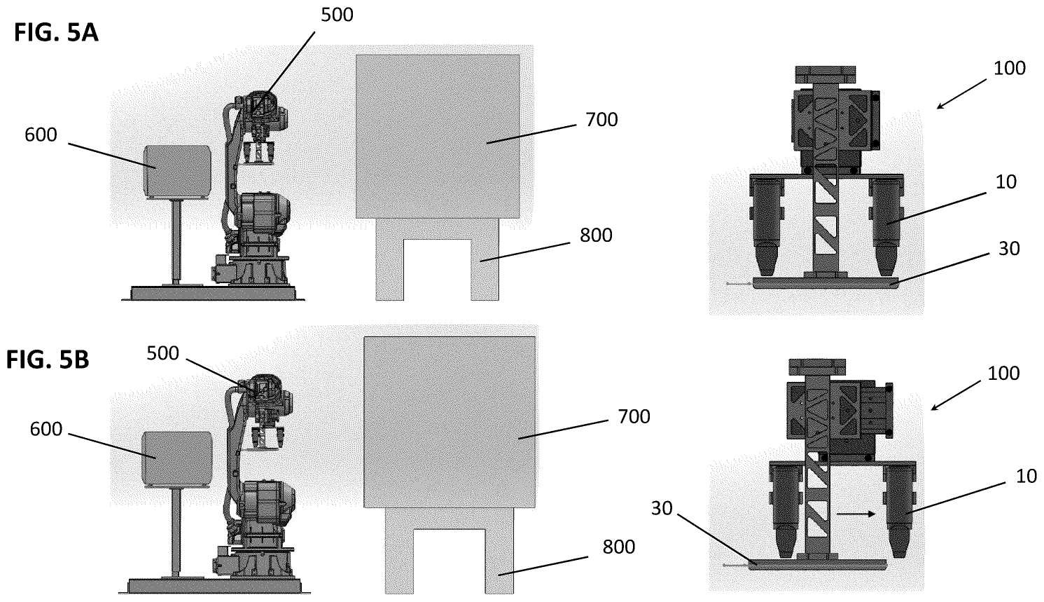

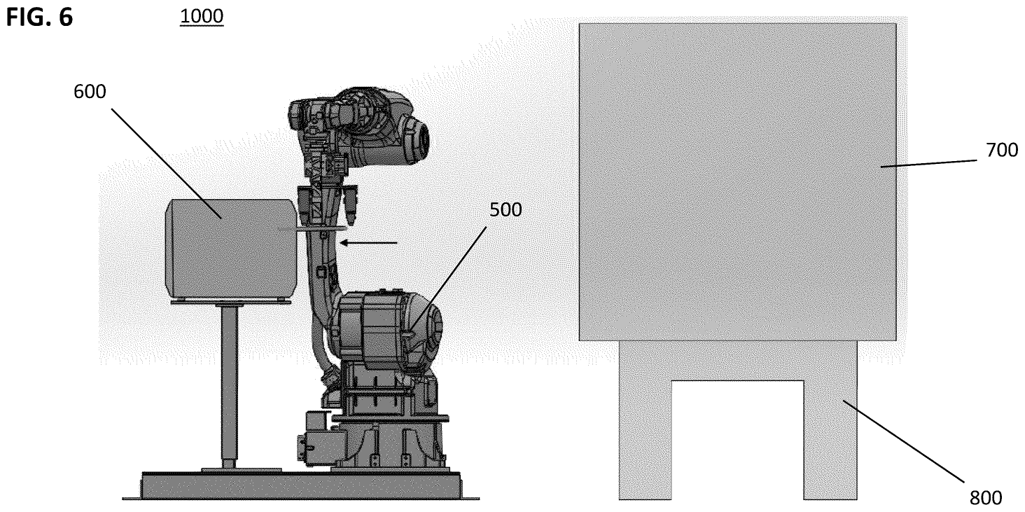

Turning now to FIG. 5A, there is shown robotic arm 500 and label applicator 100 prior to label applicator 100 being moved to the label pick-up position. As can be seen in FIG. 5A, right-hand side, label fastener 10 is in the first configuration, with label fastener 10 and label holder 30 centrally aligned relative to central mounting assembly 22, and with staple guns 12 aligned with recessed positons 24. Robotic arm 500 then proceeds to move label applicator 100 to the label pick-up position, shown in FIG. 6, with label applicator 100 positioned adjacent to label dispenser 600. Before label applicator 100 reaches the label pick-up position, label fastener 10 is translated relative to label holder 30 (as can be seen in FIG. 5B, right-hand side). According to some embodiments, the translation may be at least 1.5 inches.

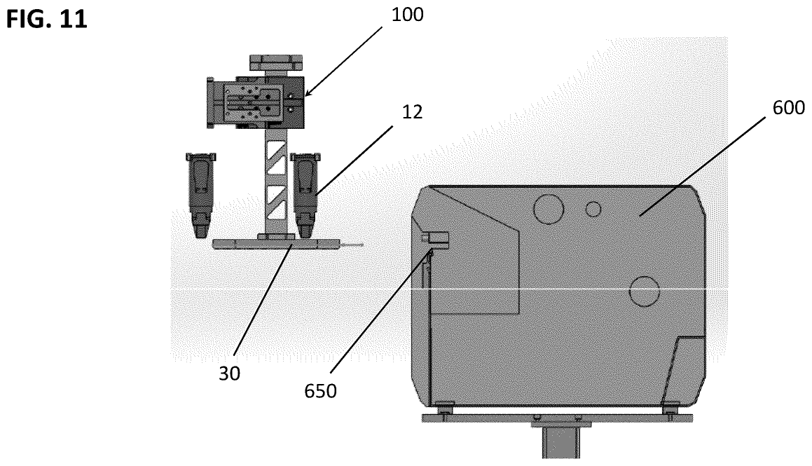

Turning now to FIG. 11, there is shown label dispenser 600 and label applicator 100 with label fastener 10 in the second position relative to label holder 30. Label dispenser 600 includes a label dispensing member 650 configured to dispense a label (not shown) in a horizontal orientation such that the dispensed label is parallel to the surface of vacuum pad 31. Label dispenser 600 may be configured to dispense non-adhesive or adhesive labels. With non-adhesive labels, a potentially wider selection of label material may be used, in particular material that is stronger/thicker and more durable. With adhesive labels, the label may be able to self-adhere to the product which may assist in keeping the label on the product if, for example, there is a malfunction with any of the staples being applied to the label, as described in further detail below.

The advantage of the adhesive label would be that the label would be able to self-adhere to the package which could potentially help keep the label on the package if there was a malfunction or error with any of the staples being applied to the package.

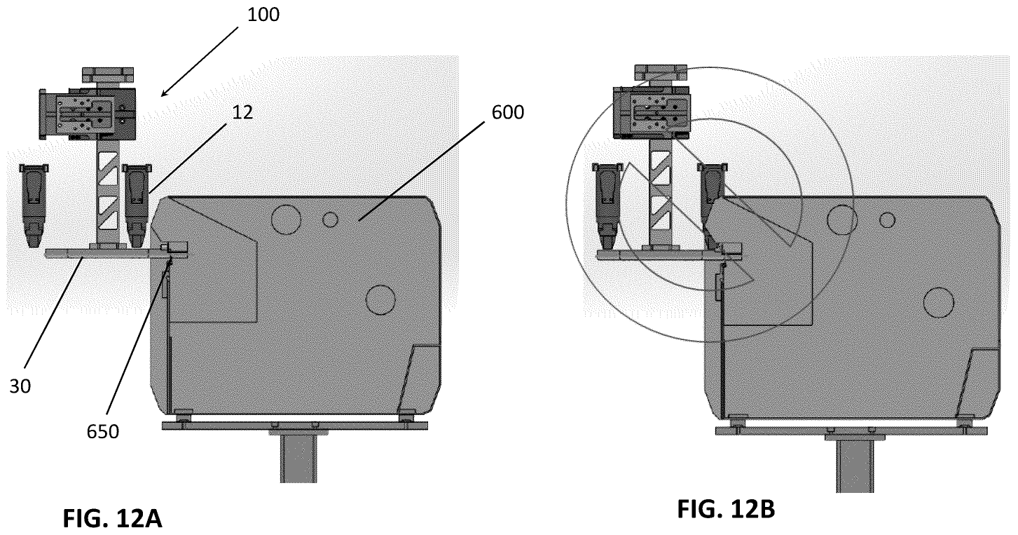

As now seen in FIG. 12A, sliding label fastener 10 relative to label holder 30 enables vacuum pad 31 to be positioned adjacent label dispensing member 650 without label fastener 10 interfering with label dispenser 600. This permits vacuum pad 31 to be brought sufficiently close to label dispensing member 650 such that the dispensed label may be immediately gripped by vacuum pad 31 as the label is dispensed from label dispensing member 650. In other words, additional clearance is provided between vacuum pad 31 and label dispensing member 650 to enable a label dispensed from label dispensing member 650 to be effectively gripped by label holder 30. The movability that is provided between label fastener 10 and label holder 30 therefore enables improved gripping of labels dispensed from label dispenser 600. As shown in FIG. 12B, with label applicator 100 in the configuration with label fastener 10 and label holder 30 both centrally aligned relative to central mounting assembly 22 (i.e. when label fastener 10 is not offset relative to label holder 30), insufficient clearance is provided between vacuum pad 31 and label dispensing member 650 to enable a label dispensed from label dispenser 600 to be effectively gripped by vacuum pad 31.

Turning now to FIG. 6, robotic arm 500 is shown in the label pick-up position as described above. In the label pick-up position shown in FIG. 6, the configuration of label applicator 100 is the same as shown in FIG. 12A.

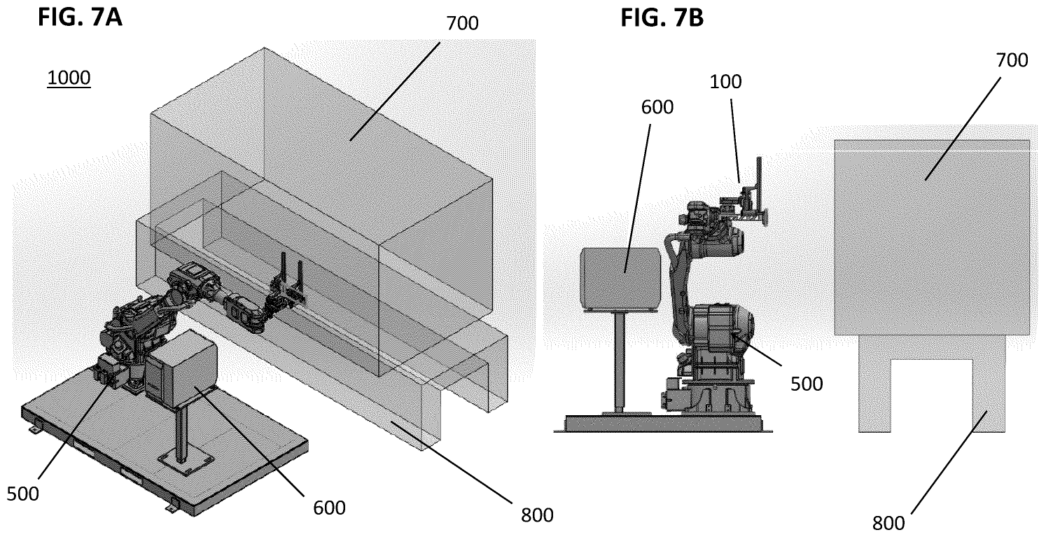

In FIGS. 7A and 7B, after having picked up a label, robotic arm 500 is seen transitioning from the label pick-up position to the label-attaching position. During this transition, label fastener 10 may be moved back from its second configuration to its first configuration. It is generally not important at what stage of the transition from the label pick-up position to the label-attaching position this repositioning of label fastener 10 relative to label holder 30 takes place.

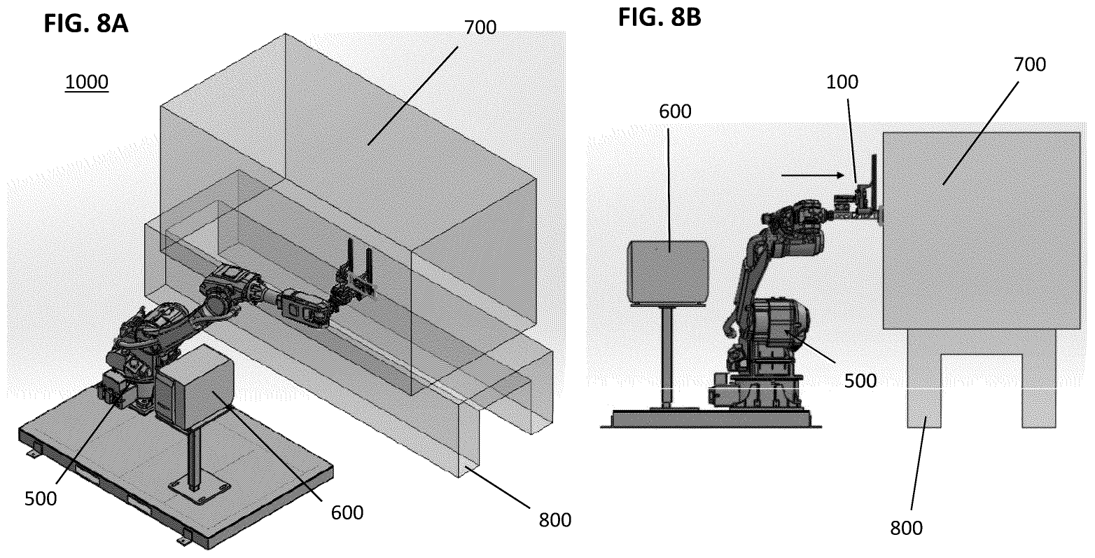

With reference now to FIGS. 8A and 8B, robotic arm 500 is shown positioning label applicator 100 in the label-attaching positon. In this position, robotic arm 500 is controlled such that label applicator 100 is positioned directly adjacent lumber 700, with the label gripped by label holder 30 being positioned in contact with lumber 700.

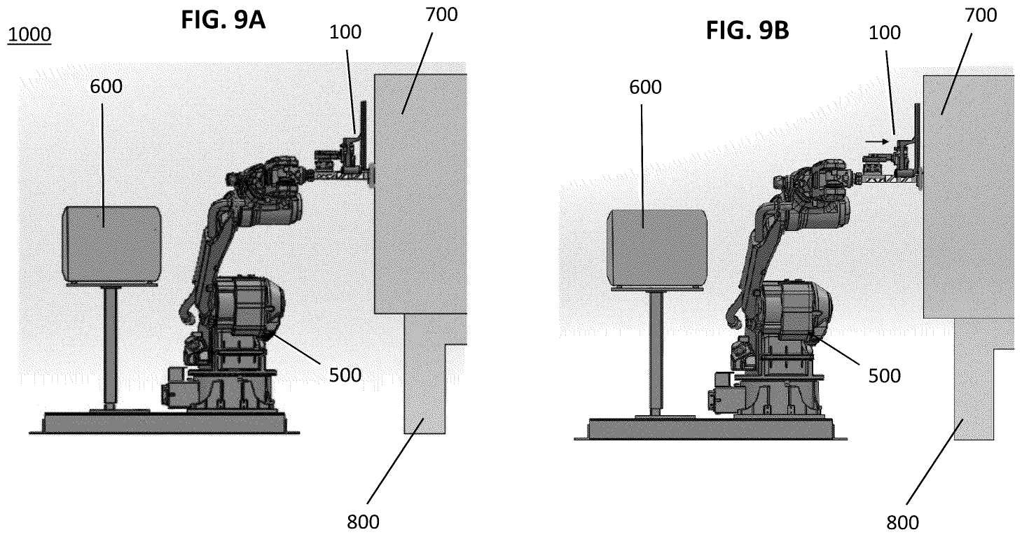

Referring now to FIGS. 9A and 9B, there is shown and described a label-attaching operation in which label fastener 10 attaches the gripped label to lumber 700. Starting first at the position shown in FIG. 9A, label applicator 100 is in its first configuration as shown in FIG. 2A. Label applicator 100 then transitions from the first configuration to the third configuration shown in FIG. 2C. In particular, label fastener 10 is translated forward such that staple guns 12 are brought into contact with portions of the label that overlap recessed portions 24 of vacuum pad 31. Staple guns 12 are then activated and drive staples into the label and lumber 700, thereby attaching the upper corners of the label to lumber 700. Subsequently, staples guns 12 are retracted by transitioning label fastener 10 from the second configuration back to the first configuration.

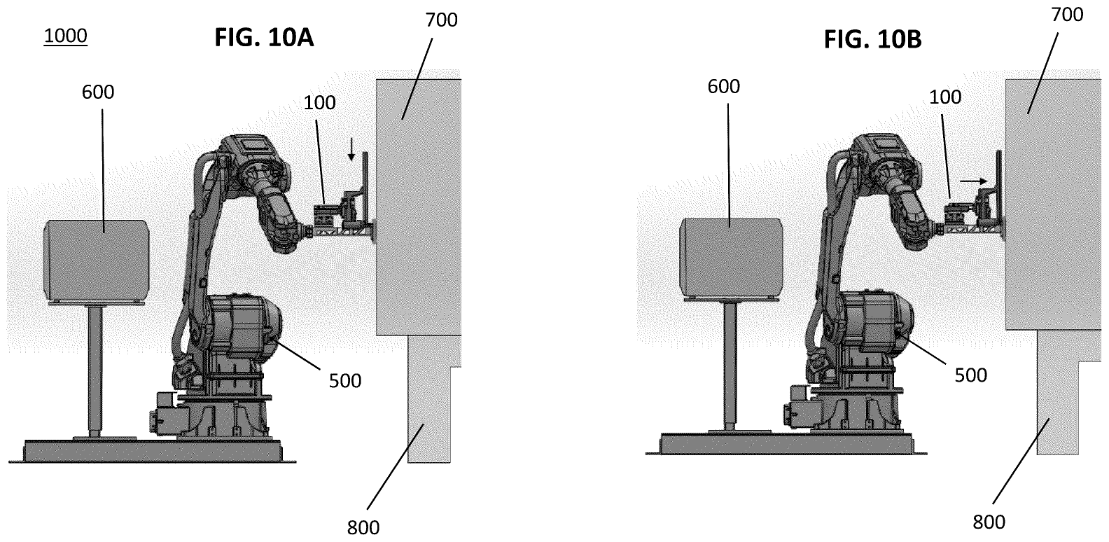

Turning now to FIG. 10, vacuum pad 31 is able to release the label since the label is already secured to lumber 700. Robotic arm 500 then repositions label applicator 100 relative to lumber 700 by moving label applicator 100 downwardly and bringing vacuum pad 31 back into contact with the fastened label (FIG. 10A). In this position, recessed portions 24 of vacuum pad 31 overlap the lower corners of the label. In order to complete the fastening operation, label fastener 10 is activated once more to bring staple guns 12 from the first configuration back to the second configuration. Staple guns 12 are then activated and drive staples into the label and lumber 700, thereby attaching the lower corners of the label to lumber 700. Stapling all four corners of the label to lumber 700 provides an improved fastening of the label to lumber 700.

The order in which different portions of the label are fastened to lumber 700 is not important, and according to other embodiments the lower corners of the label may first be secured to lumber 700, followed by the upper corners, for example.

Following the fastening of the label to lumber 700, conveyor 800 may convey lumber 700 to a different location (for example, for transport onto a vehicle). A new lumber product may then be conveyed into position, and robotic arm 500 may proceed to pick-up a new label and attach the label to the new lumber product, as described above.

While the above embodiments have been described in the context of a label fastener moving relative to a label holder, according to other embodiments it may be the label holder that is moved relative to the label fastener. According to some embodiments, the label holder performs some of the total movement, and the label fastener performs some of the total movement. More generally, the disclosure extends to label applicators in which any kind of relative one-dimensional or multi-dimensional movement between the label fastener and the label holder is possible. Furthermore, forms of movement other than translation are possible, such as rotational movement.

According to some embodiments, the label fastener may be entirely omitted, for example if self-adhesive labels are being used. In such a case, it may only be necessary for the label holder to grip the label on the non-adhesive side, hold the label against the product such that the label adheres to the product, and then release the label.

The terms “a” or “an” when used in conjunction with the terms “comprising” or “including” in the claims and/or the specification can mean “one” but it is also consistent with the meaning of “one or more”, “at least one”, and “one or more than one” unless the content clearly dictates otherwise. Similarly, the word “another” may mean at least a second or more, unless the content clearly dictates otherwise.

The terms “coupled”, “coupled”, or “connected” as used herein, may have a number of different meanings depending on the context in which the terms are used. For example, the terms coupled, or connected may have a mechanical or electrical meaning. For example, as used herein, the terms coupled, or connected may indicate that two elements or devices are connected to each other directly or via one or more intermediate elements or devices via electrical, or mechanical elements, depending on the particular context. The term “and/or” as used herein when used in association with a list of items refers to any one or more of the items comprising the list.

As used herein, reference to “about” or “approximately” a number or “substantially” is equal to a number means within +/−10% of the number.

While the disclosure has been described in connection with specific embodiments, it is to be understood that the disclosure is not limited to these embodiments, and that alterations, modifications, and variations of these embodiments may be carried out by the skilled person without departing from the scope of the disclosure.

It is furthermore contemplated that any part of any aspect or embodiment discussed in this specification can be implemented or combined with any part of any other aspect or embodiment discussed in this specification.

1. A device for applying a label to a product, comprising:
a movable arm; and
a label applicator attached to the arm, wherein the label applicator comprises:
a label holder comprising a front surface for gripping the label; and
a label fastener for attaching the label to the product,
wherein the label fastener is translatable relative to the label holder in a direction parallel to the front surface.

2. The device of claim 1, wherein the product comprises lumber.

3. The device of claim 1, wherein the label holder comprises a vacuum-generating device.

4. The device of claim 1, wherein the label fastener comprises at least one staple gun.

5. The device of claim 1, wherein the arm is movable to position the label holder in an orientation such that the label fastener is movable relative to the label holder within a horizontal plane.

6. The device of claim 1, wherein the arm is an articulated arm operable to move within at least four degrees of freedom.

7. The device of claim 1, wherein the label fastener is movable between a first position and a second position relative to the label holder, and wherein the label fastener is further movable between the first position and a third position relative to the label holder.

8. The device of claim 7, wherein, when in the third position, the label fastener extends beyond the front surface of the label holder.

9. The device of claim 7, wherein the label holder comprises at least one recessed portion for enabling the label fastener to move from the first position to the third position relative to the label holder.

10. The device of claim 1, wherein the label fastener is translatable relative to the label holder by at least 1.5 inches in the direction parallel to the front surface.

11. The device of claim 1, further comprising one or more controllers configured to:
translate the label fastener relative to the label holder;
move the arm to position the label applicator in a label pick-up position relative to a label dispenser operable to dispense the label;
activate the label holder to grip the dispensed label;
move the arm to position the label applicator in a label-attaching position relative to the product; and
activate the label fastener to attach the gripped label to the product.

12. The device of claim 11, wherein the one or more controllers are further configured to activate the label fastener by:
activating the label fastener to attach a first portion of the gripped label to the product;
move the label fastener relative to the label holder; and
activate the label fastener to attach a second portion of the gripped label to the product.

13. A system comprising:
a label dispenser operable to dispense a label; and
a device for applying the label to a product, comprising:
a movable arm; and
a label applicator attached to the arm, wherein the label applicator comprises:
a label holder comprising a front surface for gripping the label; and
a label fastener for attaching the label to the product,
wherein the label fastener is movable relative to the label holder such that sufficient clearance is provided to enable the label holder to grip the label dispensed by the label dispenser.

14. The system of claim 13, wherein the label dispenser is operable to dispense the label in a horizontal orientation.

15. The system of claim 13, wherein the label is a non-adhesive label.

16. A method of applying a label to a product, wherein:
the method uses a label applicator comprising:
a label fastener; and
a label fastener movable relative to the label holder; and
the method comprises:
moving the label fastener relative to the label holder such that sufficient clearance is provided to enable the label holder to grip the label dispensed by a label dispenser;
positioning the label applicator in a label pick-up position relative to the label dispenser operable to dispense the label;
gripping the dispensed label with the label holder;
positioning the label applicator in a label-attaching position; and
attaching the gripped label to the product with the label fastener.

17. The method of claim 16, wherein the label dispenser is operable to dispense the label in a horizontal orientation.

18. The method of claim 16, wherein the label is a non-adhesive label.
